(19) United States
(12) Patent Application Publication
(10) Pub. No.: US 2008/0051997 A1
(43) Pub. Date: Feb. 28, 2008

(54) Method, System, And Apparatus For Maintaining A Street-level Geospatial Photographic Image Database For Selective Viewing

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/846,530

(22) Filed: Aug. 29, 2007

Related U.S. Application Data
(63) Continuation of application No. 11/341,025, filed on Jan. 27, 2006.
(60) Provisional application No. 60/685,219, filed on May 27, 2005.

(51) Int. Cl. G01C 21/32

(52) U.S. Cl. 701/211

(57) ABSTRACT

A system is disclosed for creating and providing interactive access to, a street-based photographic image database. A plurality of street-level photographic images are captured are stored for each of a plurality of locations along each of a plurality of streets. The photographs depict a first-person view as would be seen by user if traveling down the associated streets. The photographs are stored in a database, indexed with respect to at least one of, the street of travel, the location upon a street of travel, a direction of vehicle flow upon the street of travel, a seasonal condition, a lighting condition, a weather condition, and a traffic condition. The photographs may be interactively accessed and displayed in response to user input and in accordance with one or more indices. An image collection system and method is also disclosed comprising a processor-controlled digital camera mounted upon a ground vehicle. Street-level images are automatically collected at incremental distances along each of plurality of streets of travel, each of the images being indexed with respect to unique correlation data.

This application is a continuation application according to 35 U.S.C. §120 of U.S. Ser. No. 11/341,025 for “IMAGE-ENHANCED VEHICLE NAVIGATION SYSTEMS AND METHODS” filed Nov. 30, 2006, which is a non-provisional application claiming priority under 35 U.S.C. §119(e) to provisional U.S. Ser. No. 60/685,219, filed May 27, 2005. This application is also related to U.S. Ser. No. 11/683,394 for “FIRST PERSON VIDEO-BASED TRAVEL PLANNING SYSTEM” filed Mar. 7, 2007 which is a continuation-in-part according to 35 U.S.C. §120 of U.S. Ser. No. 11/341,025 for “IMAGE-ENHANCED VEHICLE NAVIGATION SYSTEMS AND METHODS” filed Nov. 30, 2006, all of which are incorporated in its entirety herein by reference.

### BACKGROUND

1. Field of Invention

Embodiments disclosed herein relate generally to image capture, image storage, and image access methods and technologies. More specifically, embodiments disclosed herein relate to enhanced navigation systems that support methods and apparatus for capturing, storing, and accessing first-person driver's eye images that represent what a driver will see at various navigation destinations and intermediate locations.

2. Discussion of the Related Art

Combining the prevalence and power of digital cameras and handheld GPS devices, a website has been developed by the United States Geological Survey (USGS) called confluence.com. This web site is a storage location for digital photographs, indexed by latitude and longitude, the photographs depicting a camera view captured at those particular latitude and longitude locations around the globe. For example, one or more photographs captured at the latitude, longitude coordinate (36° N, 117° W) are stored at the website and accessible by their longitude and latitude coordinates (36° N, 117° W). In this way, a person who is curious about what the terrain looks like at that location (which happens to be Death Valley, Calif.) can view it by typing in the latitude and longitude coordinates or by selecting those coordinates off a graphical map. Photographs are included not for all values of latitude and longitude, but only for points that have whole number latitude, longitude coordinates such as (52° N, 178° W) or (41° N, 92° W) or (41° N, 73° W). Such whole number latitude, longitude coordinates are called “confluence points”, hence the name of the website. The confluence points offer a valuable structure to the photo database, providing users with a coherent set of locations to select among, most of which have pictures associated with them. This is often more convenient than a freeform database that could include vast number of locations, most of which would likely not have picture data associated with them.

A similar web-based technology has been developed subsequently by Microsoft called World Wide Media Exchange (WWMX) that also indexes photographs on a web server based upon the GPS location at which the photo was captured. The Microsoft site is not limited to confluence points, allowing photographs to be associated with any GPS coordinate on the surface of the earth. This allows for more freedom than the confluence technology, but such freedom comes with a price. Because there are an incredibly large number of possible coordinates and because all GPS coordinates are subject to some degree of error, users of the WWMX website may find it difficult to find an image of what they are looking for even if they have a GPS location to enter. Part of the technology developed by Microsoft is the searchable database of photographs cataloged by GPS location and user interface as described in US Patent Application Publication No. 2004/0225635, which is hereby incorporated by reference. This document can be understood to disclose a method and system for storing and retrieving photographs from a web-accessible database, the database indexing photographs by GPS location as well as the time and date the photo was captured. Similarly, US Patent Application Publication No. 2005/0060299, which is hereby incorporated by reference, can be understood to disclose a method and system for storing and retrieving photographs from a web-accessible database, the database indexing photographs by location, orientation, as well as the time and date the photo was captured

While confluence.com and the other web accessible database technologies are of value as an educational tool, for example allowing students to explore the world digitally, viewing terrain at a wide range of locations from the north pole to the equator to the pyramids of Egypt, by simply typing in the latitude, longitude pairs, the methods and apparatus used for storing and accessing photographs indexed by latitude and longitude can be expanded to greatly increase the power and usefulness of such systems.

### SUMMARY

Several embodiments of the invention address the needs above as well as other needs by providing image-enhanced vehicle navigation systems and methods.

One exemplary embodiment disclosed herein provides a method of presenting images to a user of a vehicle navigation system that includes accessing location data indicating a particular location included within a route determined by a vehicle navigation system and accessing direction data corresponding to the location data. The accessed direction data indicates a particular direction in which a user's vehicle will be traveling when the user's vehicle reaches the particular location via the route. The method further includes obtaining a captured image based on the accessed location and direction data and displaying the obtained image within the user's vehicle. The obtained captured image corresponds approximately to a driver's perspective from within a vehicle and depicting a view of the particular location along the particular direction.

Another exemplary embodiment disclosed herein provides a method of presenting images to a user of a vehicle navigation system that includes capturing an image depicting a view corresponding approximately to a driver's perspective from within a first vehicle and correlating the captured image with location data and direction data. The location data indicates a location of the first vehicle when the image was captured while the direction data indicates a direction of travel in which the first vehicle was traveling when the image was captured. The method further includes storing the captured image correlated with the location and direction data within a data memory and transmitting the stored captured image to a user's vehicle navigation system. The stored captured image can be transmitted to a vehicle navigation system of a second vehicle when the second vehicle is following a route that is predicted to approach the location along the direction of travel.

A further exemplary embodiment disclosed herein provides a local processor aboard a vehicle and a display screen aboard the vehicle and coupled to the local processor. The local processor contains circuitry is adapted to access location data indicating a particular location included within a route, access direction data corresponding to the location data and indicating a particular direction in which the vehicle will be traveling when the user's vehicle reaches the particular location via the route, obtain a captured image based on the accessed location and direction data, and drive the display screen to display the obtained image. The obtained captured image corresponds approximately to a driver's perspective from within the vehicle and depicting a view of the particular location along the particular direction.

Yet another exemplary embodiment disclosed herein provides an image capture system that includes a camera coupled to a vehicle and a local processor aboard the vehicle and coupled to the camera. The camera is adapted to capture an image of a location corresponding approximately to a driver's perspective from within a vehicle. The local processor contains circuitry is adapted to receive location data and direction data and correlate the captured image with the location and direction data. The location data indicates a particular location of the vehicle when the image was captured while the direction data indicates a particular direction in which the vehicle was traveling when the image was captured. The local processor contains circuitry is further adapted to store the captured image correlated with the location and direction data and upload the stored captured image to a remote data store.

Still another exemplary embodiment disclosed herein provides a method of presenting images to a user of a vehicle navigation system that includes accessing location data indicating a particular location included within a route determined by a vehicle navigation system and accessing direction data corresponding to the location data. The accessed direction data indicates a particular direction in which a user's vehicle will be traveling when the user's vehicle reaches the particular location via the route. The method further includes obtaining a captured image based on the accessed location and direction data and displaying the obtained image within the user's vehicle. The obtained captured image corresponds approximately to a driver's perspective from within a vehicle and depicting a view from the particular location along the particular direction.

One additional exemplary embodiment disclosed herein provides a local processor aboard a vehicle and a display screen aboard the vehicle and coupled to the local processor. The local processor contains circuitry is adapted to access location data indicating a particular location included within a route, access direction data corresponding to the location data and indicating a particular direction in which the vehicle will be traveling when the user's vehicle reaches the particular location via the route, obtain a captured image based on the accessed location and direction data, and drive the display screen to display the obtained image. The obtained captured image corresponds approximately to a driver's perspective from within the vehicle and depicting a view from the particular location along the particular direction.

As exemplarily disclosed herein, the location data may include spatial coordinates such as GPS data and/or other locative data. Location data may also include a street index and/or other locative data relative to a particular street or intersection. Additionally, and as exemplarily described herein, data indicating a time-of-day, season-of-year, and ambient environmental conditions such as weather conditions, lighting conditions, traffic conditions, etc., and the like, and combinations thereof, may also be used to obtain and/or store captured images.

### BRIEF DESCRIPTION OF THE DRAWINGS

The above and other aspects, features and advantages of several embodiments of the embodiments exemplarily described herein will be more apparent from the following more particular description thereof, presented in conjunction with the following drawings.

FIG. 1 illustrates an interface of an exemplary navigation system incorporated within an automobile;

FIG. 2 illustrates an exemplary interface of an image-enhanced vehicle navigation system in accordance with one embodiment;

FIG. 3 illustrates an exemplary chart of actual sunrise and sunset times for the month of March 2005 for the location San Jose, Calif.; and

FIGS. 4A and 4B illustrate two first person driver's eye images captured at similar locations and at similar times of day, wherein FIG. 4A illustrates an image captured under winter environmental conditions and

FIG. 4B illustrates an image captured under summer environmental conditions.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be captured in a limiting sense, but is made merely for the purpose of describing the general principles of exemplary embodiments. The scope of the embodiments disclosed below should be determined with reference to the claims.

FIG. 1 illustrates an interface of an exemplary vehicle navigation system within which embodiments disclosed herein can be incorporated.

Referring to FIG. 1, vehicle navigation systems often include a display screen for adapted to show maps and directions to the operator of the navigation system (e.g., the driver of the vehicle). U.S. Pat. No. 5,359,527, which is hereby incorporated by reference, can be understood to disclose that such vehicle navigation systems implement navigation planning routines adapted to provide an operator with a route from a present position of a vehicle to a concrete destination location by displaying the route on a map-like display. Such a system often includes destination decision processing software that derives a plurality of candidate destinations from map data stored in memory according to a general destination input by the user, and displays the candidates on the display screen. Such a system also often includes route search processing software that searches a route from the present position to one of the candidates which has been selected by the operator, and displays the searched route on the display. U.S. Pat. No. 5,442,557, which is also hereby incorporated by reference, can be understood to disclose a vehicle navigation system implementing a navigation planning routine that uses a positioning system such as GPS, a store of geographic map information, as well as other information (e.g., the location of landmarks).

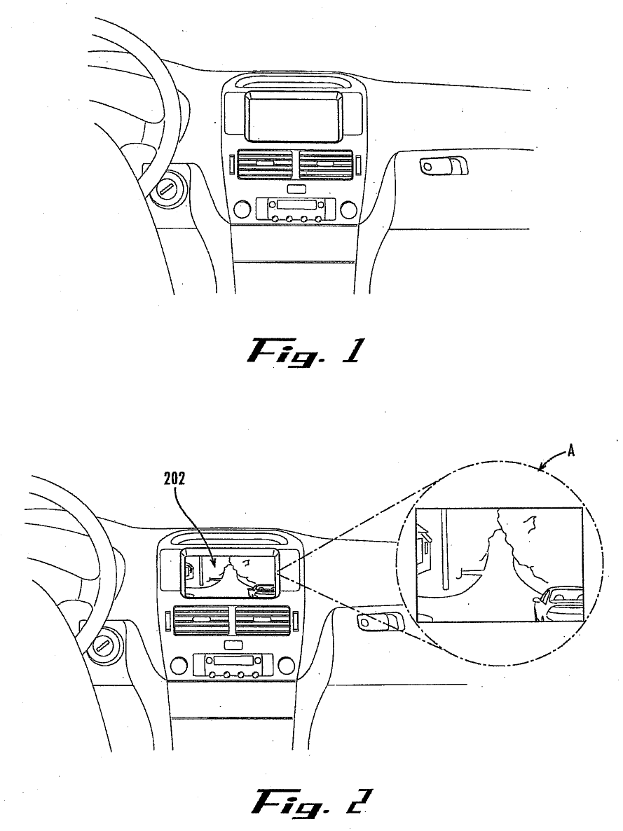

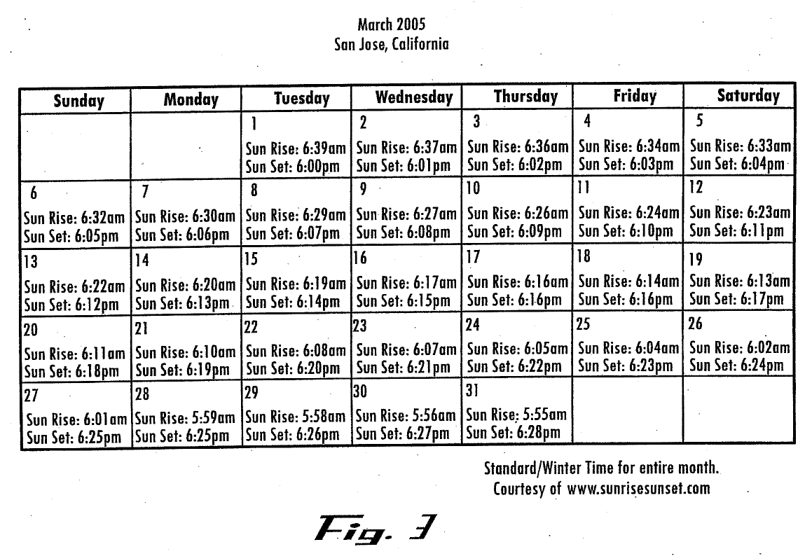

FIG. 2 illustrates an exemplary interface of an image-enhanced vehicle navigation system in accordance with one embodiment of the present invention.

Referring to FIG. 2, an image-enhanced vehicle navigation system (i.e., a vehicle navigation system such as that described above with respect to FIG. 1 and incorporating embodiments exemplarily disclosed herein) includes a display screen 202 adapted to display images captured in accordance with the exemplary embodiments described herein. A more detailed view of the image displayed by display screen 202 is shown in blow-up section “A”. As exemplarily illustrated, captured images depict a first-person driver's eye view of a location that the driver is looking for in the distance. Accordingly, the image-enhanced vehicle navigation system allows users to preview specific views they will see from their own vehicle (e.g., an automobile such as a car) when they reach a particular location. The particular location may be final or destination location of a driving route or an intermediate location between a current location of the vehicle and the destination location (e.g., at a location where they need to make a turn, take an exit, or otherwise take some driving action or monitor their progress along a driving route).

It will also be appreciated that the display screen 202 may also be driven as, for example, described in U.S. Pat. Nos. 5,359,527 and 5,442,557 to display maps and directions. In one embodiment, users can engage a user interface of the image-enhanced vehicle navigation system to selectively switch between the type of display exemplarily shown in FIG. 2 and the type of display exemplarily shown in FIG. 1. It will also be appreciated that the image-enhanced vehicle navigation system may also provide the user with additional functionality as is typically found in conventional vehicle navigation systems.

According to numerous embodiments disclosed herein, and as will be described in greater detail below, an image-enhanced vehicle navigation system enables captured digital images (e.g., photographs) to be made accessible to drivers via, for example, the display screen 202. In another embodiment, an image-capture system enables such digital images to be captured, indexed according to correlation data, stored, and made accessible to users of the image-enhanced vehicle navigation system. In still another embodiment, the image-capture system may be integrated within the image-enhanced navigation system. Generally, the image-enhanced vehicle navigation system (and the image-capture system, if separate from the image-enhanced vehicle navigation system) includes one or more local processors (generically referred to simply as a local processor) aboard the user's vehicle, and a data memory either aboard the vehicle and coupled to the local processor (i.e., a local data store) or otherwise accessible to the local processor (e.g., via a two-way wireless network connection to a remote data store). Generally, the local processor may be provided with circuitry adapted to perform any of the methods disclosed herein. As used herein, the term “circuitry” refers to any type of executable instructions that can be implemented as, for example, hardware, firmware, and/or software, which are all within the scope of the various teachings described.

According to numerous embodiments, the image-enhanced vehicle navigation system is adapted to display (and the image-capture system is adapted to capture) digital images depicting a view corresponding approximately to that which a driver's perspective when sitting in their vehicle (e.g., in the driver's seat). To acquire such first person driver's eye views, the image capture system, either separate from or integrated within the image-enhanced vehicle navigation system, may be provided with a device such as a digital camera coupled to a vehicle such that the camera is aimed forward with a direction, height, focal length, and field of view to capture images that are substantially similar to what a human driver would actually see when looking forward out the front windshield of a vehicle sitting in the driver's seat of the vehicle.

In one embodiment, the digital camera may be mounted on or near the where the roof of the vehicle (e.g., an automobile) meets the windshield of the vehicle, directly above the driver. For 35 mm style digital camera optics, a 50 mm lens has been found to approximate the field of view of natural human vision. In one embodiment, a rear-facing camera may be mounted upon the vehicle to capture the image a driver would see as if the vehicle was going the opposite direction along the street. In this case, a camera may be mounted on or near the where the roof of the vehicle meets the rear windshield of the vehicle, above the driver side of the vehicle.

In one embodiment, the image capture system automatically captures images in response to the occurrence of one or more predetermined image capture events. Where the image capture system is integrated with the image-enhanced vehicle navigation system, the digital camera may be interfaced with the local processor. Accordingly, the local processor may contain circuitry adapted to automatically instruct the digital camera to capture one or more digital images in response to the occurrence of one or more predetermined image capture events.

In one embodiment, a predetermined image capture event includes movement of the vehicle by a certain incremental distance. Accordingly, the local processor may be adapted to receive data from the GPS sensor, determine whether the vehicle has moved a certain incremental distance based on changing data received from the GPS sensor, and instruct the camera to capture an image every time the vehicle moves a certain incremental distance.

Vehicles often come to a stop at intersections that may serve as useful visual reference points for drivers. Accordingly, another predetermined image capture event can include a vehicle stopping. Thus, in another embodiment, the local processor may be adapted to instruct the digital camera to capture an image every time the vehicle comes to a stop.

Useful images are often captured as the vehicle is approaching an intersection. Accordingly, another predetermined image capture event can include a vehicle slowing to a stop. Thus, in another embodiment, the local processor may contain circuitry adapted to instruct the camera to capture an image not when the vehicle comes to a complete stop but when the vehicle is slowing to a stop. The determination of “slowing” can, in one embodiment, be made based upon a measured deceleration of the vehicle that is greater than a threshold value. The determination of “slowing” can, in another embodiment, be made based upon a measured deceleration of the vehicle that is greater than a threshold value and lasting longer than a threshold time period.

Drivers often activate a turn signal when the vehicle they are driving approaches an intersection, exit, driveway, and/or other location that may serve as useful visual reference point for drivers. Accordingly, another predetermined image capture event can include the driver activating a turn signal. Thus, in another embodiment, the local processor may be adapted to instruct the camera to capture an image every time the driver puts on the turn signal.

Sometimes the driver may engage the turn signal to pass a vehicle and/or change lanes, but not because he or she is approaching an intersection, exit, driveway, etc. In such cases, the vehicle will likely remain at the same speed and/or increase in speed. On the other hand when the vehicle is approaching a turn, the signal will go on and the driver will usually begin to slow the vehicle. Accordingly, another predetermined image capture event can include the driving activating a turn signal and decelerating (e.g., by removing pressure from the gas pedal). Thus, in another embodiment, the local processor may be adapted to instruct the camera to capture an image every time the driver engages the turn signal and removes pressure from the gas pedal at or near the same time.

In another embodiment, the local processor may be adapted to access a location database containing locations of streets, intersections, exits, etc., determine the current location of the vehicle, and instruct the camera to capture an image if it is determined that the vehicle is approaching a location within the location database. The location database may be stored in memory either aboard the vehicle or accessible to the local processor aboard the vehicle.

It will be understood that various embodiments of the automated image capture process described in the paragraphs above may be implemented alone or in combination.

As discussed above, one embodiment of the image capture system enables images to be captured automatically. In another embodiment, however, the image capture system enables images to be captured in response to manual input by the user. Accordingly, where the image capture system is integrated with the image-enhanced vehicle navigation system, the image capture system may include a user interface adapted to be engaged by the user, allowing the user to instruct the digital camera to capture an image at a given moment. For example, and in one embodiment, one or more images may be captured in response to an instruction manually input by the user as circuitry within the local processor causes the digital camera to automatically capture images in response to predetermined image capture events. In this way, the images can be automatically captured as discussed above while the user can manually initiate image capture at a given moment in time.

In one embodiment, the user interface is embodied as a button or other manual control within the vehicle, coupled to the local processor. For example, the button may be provided as a finger activated pushbutton, a lever mounted upon the steering wheel, steering column, or an easily accessible area of the dashboard of the user's vehicle, or a graphical selection button supported by the display screen 202.

Images captured in accordance with the aforementioned image capture system may be stored within an image database contained within the aforementioned data memory and indexed according to correlation data describing circumstances in existence when each image was captured. Accordingly, the local processor of the image capture system may contain circuitry adapted to cause captured images and the correlation data to be stored within the image database. As will be described in greater detail below, correlation data can include location data (e.g., data indicating the GPS location of the vehicle, the street index (e.g., name) upon which the vehicle was located, etc.), the direction data indicating the direction of travel of the vehicle (e.g., with respect to the earth or with respect to a street upon which the vehicle was located), environmental data indicating environmental conditions (e.g., light data indicating lighting conditions, weather data indicating weather conditions, season data indicating seasonal conditions, traffic data indicating traffic conditions, etc.), and other data indicating date, time, vehicle speed, and the like, or combinations thereof.

In one embodiment, the correlation data describing data the GPS location of a vehicle includes the actual GPS location of the vehicle when the image was captured and/or a link to the GPS location of the vehicle when the image was captured. Accordingly, the local processor may contain circuitry adapted to store captured images and along with data indicating the GPS location of the vehicle when the digital image was captured. In another embodiment, the corresponding GPS location may be provided in the form of longitude and latitude coordinates or may be converted into any other spatial coordinate format when storing and accessing image data. In yet another embodiment, altitude data (which is also accessible from GPS data) may also be used to increase locative accuracy, for example, on streets that wind up and down steep hills.

A single GPS location can be associated with vehicles moving in more than one direction. Accordingly, the local processor may contain circuitry adapted to store the captured digital images in memory along with data indicating the direction in which the vehicle was traveling (e.g., northbound, southbound, eastbound, or westbound) when the digital image was captured. Accordingly, stored captured images may be additionally indexed by direction of travel.

In one embodiment, the local processor may be adapted to determine the direction of travel of a vehicle, for example, upon a given street, by receiving data from the GPS sensor indicating a plurality of consecutive GPS location readings for the vehicle and computing the change in location over the change in time. In another embodiment, the local processor may be adapted to determine the direction of travel of a vehicle using orientation sensors (e.g., a magnetometer) aboard the vehicle. In another embodiment, the local processor may be adapted to determine the direction of travel of a vehicle using a combination of an orientation sensor and one or more GPS location readings. In another embodiment, the local processor may be adapted to determine the direction of travel of a vehicle by accessing a planned route within the navigation system itself and the explicitly stated destination entered by the user into the system and inferring a direction of travel based upon the location of the vehicle along the planned route. In another embodiment, the local processor may be adapted to determine the direction of travel of a vehicle by inferring the direction of travel in combination with data received from an orientation sensor and/or data indicating one or more GPS location readings.

In this way, a driver heading toward a particular location while driving in a northbound direction can access a northbound image of the particular location while a driver heading to that same particular location while driving in a southbound direction can access the southbound image of the particular location. Thus, a particular location on a two-way street, for example, may be associated with at least two images: one image for each of the two directions a vehicle can travel upon that street to or past that particular location. A particular location at a four-way intersection, for example, may be associated with at least four images: one image for each direction a vehicle can travel to or past that particular location. It will be readily apparent that, in some embodiments, more than four travel directions may exist and, therefore, a particular location may be associated with more than four different images.

GPS location data can be subject to positioning error. Accordingly, the local processor may be further adapted to correlate the captured digital images stored in memory with data indicating the name of the street upon which the vehicle was traveling when the digital image was captured. Accordingly, stored captured images may be additionally indexed by street name.

In one embodiment, the local processor may be adapted to access a street database containing names of streets, streets, highways, etc., determine the current location of the vehicle, and store the name of the street upon which the vehicle was traveling when the digital image was captured based upon the determination. The street database may be stored in memory either aboard the vehicle or accessible to the local processor aboard the vehicle.

By storing and indexing the images by both street name (or other street identifying index) and GPS location, images can be both stored and accessed with increased locative accuracy.

Variations in environmental conditions can alter the view of a driver's surroundings. Accordingly, numerous embodiments disclosed herein enable captured images to be additionally indexed according to data indicating environmental conditions (e.g., lighting conditions, weather conditions, seasonal conditions, traffic conditions, and the like, or combinations thereof) present at the time when the image was captured. By storing and indexing the images by location, travel direction, and environmental condition, a plurality of different views correlated by environmental condition may be made available to drivers who are heading towards destination locations or intermediate locations thereto, to help the driver better recognize the particular scene when they come upon it.

In one embodiment, the image capture system may further include a light sensor coupled to the vehicle and contain circuitry adapted to detect ambient lighting conditions at the time when a particular image is captured. Accordingly, the light sensor may be adapted to provide data indicating outside lighting levels (i.e., light sensor data) to the aforementioned local processor. In one embodiment, the local processor may be further adapted to process the light sensor data based upon a binary threshold level to identify whether it is currently daylight or nighttime and store the results of such identification along with images captured at that time. In another embodiment, the local processor be further adapted to process the light sensor data based upon a range of light sensor data values to identify whether one of a predetermined plurality of lighting conditions (e.g., dawn, daylight, dusk, nighttime, etc.) exist and store the results of such identification along with images captured at that time. In another embodiment, values of the actual lighting sensor data provided by the light sensor may be stored and correlated with the images captured when the lighting sensor readings were captured. Because lighting conditions may vary from location to location, from season to season, and from to one cloud cover condition to another, the light sensor may include self-calibration circuitry adapted to record baseline values and/or daily average values such that lighting levels and/or lighting ranges can be normalized as part of the dawn, daylight, dusk, or nighttimes determination.

In another embodiment, a light sensor is not used in determining the ambient lighting conditions at the time when a particular image is captured. Instead, data indicating the time-of-day and day-of-year (e.g., obtained from a local clock and local calendar accessible to the local processor) is used along with a database of sunrise and sunset times for the general location at which each image was captured to both catalog the lighting conditions present when images are captured as well as a means of accessing images for particular locations and times and dates such that the accessed images match the expected lighting conditions for the drivers arrival at the location.

In one embodiment, the local processor may be adapted to access sunrise and sunset data from a sunrise/sunset database stored in memory either aboard the vehicle or accessible to the local processor aboard the vehicle. In another embodiment, the local processor may be adapted to compute sunrise and sunset data for a wide range of locations and a wide range of dates. In another embodiment, the local processor may be adapted to access sunrise and sunset data for particular locations and particular dates over a wireless network connection (e.g., over the Internet from a website such as www.sunrisesunset.com) and determine lighting conditions based upon the accessed sunrise/sunset data. FIG. 3 illustrates sunrise and sunset data for the month of March 2005 for the location San Jose, Calif. In another embodiment, the local processor may be adapted to access lighting conditions for particular locations and particular dates over a wireless network connection.

The local processor may contain circuitry adapted to access weather conditions local to the vehicle (i.e., local weather conditions). In one embodiment, local weather conditions may be accessed by correlating data from an internet weather service with GPS data reflecting the vehicles then current geographic location. Weather conditions can include one or more factors that can affect images captured such as cloud cover (e.g., clear, partly cloudy, overcast, foggy, etc.), the type and intensity of precipitation (e.g., raining, snowing, sunny, etc.), and precipitation accumulation levels (e.g. wet from rain, icy, minor snow accumulation, major snow accumulation, etc.). The weather conditions can also include other factors such a smog index or other local pollution conditions.

In accordance with numerous embodiments, the image capture system includes a user interface (e.g., embodied within a display screen such as display screen 202) adapted to be engaged by the user, allowing the user (e.g., the driver of the vehicle) to directly input the then current weather conditions to the local processor. For example, the user interface may include graphical menus adapted to be engaged by the user and allow the user to identify if the then current cloud cover is sunny, cloudy, or partly cloudy. In another example, the user interface may include graphical menus adapted to be engaged by the user and allow the user to identify if the then current precipitation is clear, raining, or snowing. In another example, the user interface may include graphical menus adapted to be engaged by the user and allow the user to identify if the then current ground cover is clear, snow covered, rain covered, or ice covered as well as optionally identifying the levels of accumulation from light to moderate to heavy.

The local processor may contain circuitry adapted to access traffic conditions local to the vehicle (i.e., local traffic conditions). In one embodiment, local traffic conditions may be accessed by correlating data from an Internet traffic service with GPS data reflecting the vehicles then current geographic location. In another embodiment, local traffic conditions may be inferred based upon a local clock and local calendar accessible to the local processor. In another embodiment, the local processor has accessible to it, from local memory or over a network connection, times and days of the week that are defined as “rush hour” periods for various local areas. The rush hour period may, in one embodiment, be defined in data memory. For example, the rush hour period may be defined as a period from 8:00 AM to 9:30 AM on the weekdays and as period from 4:30 PM to 6:30 PM on weekdays, holidays excluded.

In one embodiment, the image capture system includes a user interface (e.g., embodied within a display screen such as display screen 202) adapted to be engaged by the user and allow the user (e.g., the driver of the vehicle) to directly input the then current traffic conditions to the local processor. For example, such a user interface may include graphical menus adapted to be engaged by the user and allow the user to identify if the then current traffic is light, moderate, or heavy.

The local processor may contain circuitry adapted to determine the current season local to the driver. In one embodiment, the local processor may be adapted to determine the current season local to the driver by accessing the current date of the year and correlating the accessed date with a store of seasonal information for one or more local locations. In another embodiment, the local processor may be adapted to use data indicating the current GPS location to fine-tune the seasonal information, correlating the then current date with seasonal variations by geography. In another embodiment, the local processor may be hard-coded with information identifying which hemisphere the vehicle is located in (i.e., hemisphere information) and may further be adapted to use the hemisphere information along with the date information to determine the current season local to the driver. In another embodiment, the local processor may be adapted to determine whether or not the current season is spring, summer, winter, or fall based upon data indicating the current date and a store of date-season correlations.

The local processor may be further adapted to correlate the captured digital images stored in memory with data indicating the date and/or time at which each image was captured. In such embodiments, the local processor may not explicitly correlate seasonal conditions and/or lighting for each captured image. Rather, the local processor may use data indicating the date and/or time, along with other stored information, to derive seasonal conditions and/or lighting for each captured image. For example, the local processor can derive data indicating seasonal conditions based upon data indicating the date at which an image was captured in combination with data that correlates dates with seasons (date-season correlation data) for the location, or range of locations, within which the image was captured. In another example, the local processor can derive data indicating lighting conditions based upon data indicating the time at which an image was captured in combination with sunrise/sunset data for the particular date and location that the image was captured (or a range of dates and/or range of locations that the image was captured).

In one embodiment, the local processor of a particular image-enhanced vehicle navigation system associated with a particular vehicle may include circuitry adapted to perform navigation planning routines (e.g., as described above with respect to U.S. Pat. Nos. 5,359,527 and 5,442,557) that determine a route from a current location of a user's vehicle to a particular location included within the determined route (e.g., a destination location as entered by the user, an intermediate location between the current location and the destination location, etc.). The particular image-enhanced vehicle navigation system may also include circuitry adapted to predict or estimate when the user's vehicle will reach the particular location. The particular image-enhanced vehicle navigation system may also include any of the aforementioned sensors, databases, cameras, circuitry, etc., enabling any of the aforementioned correlation data as described in any one or more of the preceding paragraphs to be received, inferred, derived, and/or otherwise accessed for the particular location at a time corresponding to when the user's vehicle is predicted or estimated to reach the particular location. Using the received, inferred, derived, and/or otherwise accessed correlation data, the local processor of the particular image-enhanced vehicle navigation system may obtain an image from an image database that was previously captured by an image capture system (e.g., either associated with that particular vehicle or another vehicle), wherein correlation data associated with the obtained image corresponds to the correlation data received, inferred, derived, and/or otherwise accessed by the particular image-enhanced vehicle navigation system. As mentioned above, the image database may be stored in data memory either aboard the particular vehicle or be otherwise accessible to the local processor aboard the particular vehicle (e.g., via a wireless network connection to a remote data store). The display screen of the particular image-enhanced vehicle navigation system can then be driven by the local processor to display the obtained image.

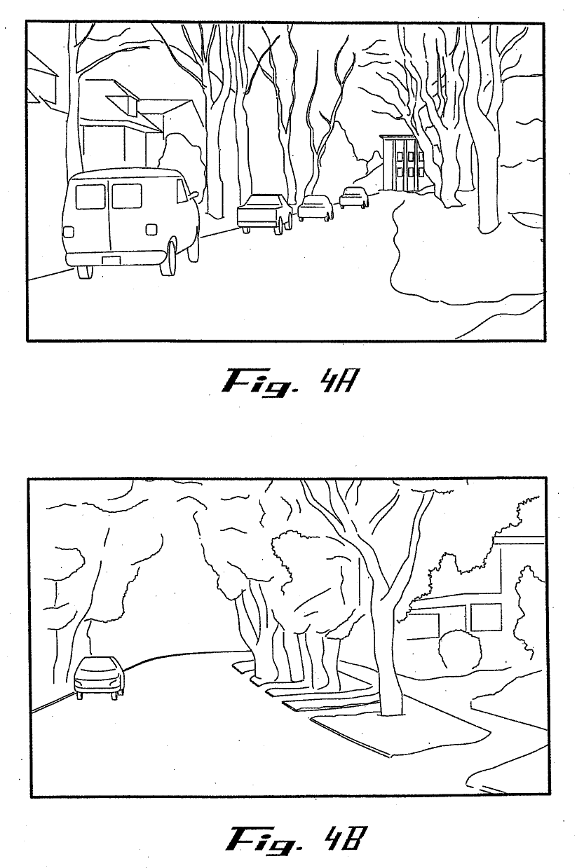

Therefore, and as described above, the local processor of a particular image-enhanced vehicle navigation system integrated within a particular vehicle is adapted to implement an image-enhanced navigation process allowing a driver of the particular vehicle to obtain and view an image of a particular location included within a determined route that corresponds to (e.g., closely matches) what he or she will expect to find when he or she approaches the particular location, based upon correlation data received, inferred, derived, and/or otherwise accessed by the particular image-enhanced vehicle navigation system. For example, if the driver is approaching a location such as a highway exit at night, an image of that exit location captured with nighttime lighting conditions may be accessed and presented to the driver by the image-enhanced vehicle navigation system. Alternately, if the driver is approaching the highway exit during the day, a daytime image of that exit location (i.e., an image of that exit location captured with daytime lighting conditions) may be accessed and presented to the driver by the image-enhanced vehicle navigation system. Similarly, the image enhanced navigation system can present sunny views, rainy views, snowy views, summer views, fall views, high traffic views, low traffic views, and other environmentally appropriate views to drivers such that they see images of their destinations that closely match what they should expect to actually see when they arrive. For purposes of illustration, FIGS. 4A and 4B show two first person driver's eye images captured at similar locations on a particular street and at similar times of day. FIG. 4A illustrates an exemplary image captured under winter environmental conditions and FIG. 4B illustrates an exemplary image captured under summer environmental conditions. As is evident, a driver's view of a particular location can vary greatly depending upon, for example, the environmental conditions present at the time the driver is actually present at a particular location. Accordingly, the image enhanced navigation system disclosed herein help a driver visually identify particular locations, whether the particular locations are the final destination of the driver or an intermediate milestone.

Where image capture systems are incorporated within image-enhanced vehicle navigation systems (herein referred to as “integrated image-enhanced vehicle navigation systems”), an automated large-scale distributed system may be provided to manage sets of images of the same or similar locations that are captured by a plurality of image-enhanced vehicle navigation systems. In one embodiment, images captured (and received, inferred, derived, determined, and/or otherwise accessed correlation data associated therewith) by individual integrated image-enhanced vehicle navigation systems may be stored locally and periodically uploaded (e.g., via a two-way wireless network connection to a remote data store) to remote data store (e.g., the aforementioned remote data store) accessible by other users of image-enhanced vehicle navigation systems (integrated or otherwise). In this way, users of integrated image-enhanced vehicle navigation systems continuously update a centralized database, providing images of their local area (including highways, major streets, side streets, etc.) that are captured according to any of the aforementioned automatic and manual image capture processes described above, and captured at various lighting conditions, weather conditions, seasonal conditions, traffic conditions, travel directions, etc.

As may occur, for example, in large metropolitan areas, a large number of vehicles may be equipped with the image capture systems and/or integrated image-enhanced vehicle navigation systems disclosed herein and may travel along the same streets. As a result, a large number of images may be captured for the same or similar location. Accordingly, and in one embodiment, the automated large-scale distributed system may include circuitry adapted to implement an “image thinning process” that facilitates processing and retrieval of large numbers of images captured for similar locations. The image thinning process may reduce the number of images stored in the remote data store and/or may prevent new images from being stored in the remote data store. In one embodiment, the automated large-scale distributed system may include one or more remote processors (generically referred to simply as a remote processor) provided with the aforementioned circuitry adapted to implement the image thinning process.

In one embodiment, the remote processor may be adapted to reduce the number of images in a set of images existing within the remote data store and/or prevent new images from being added to a set of existing images existing within the remote data store by determining whether the images are of the same or similar location (i.e., the same “location index”). In another embodiment, the remote processor may be adapted to reduce the number of images in a set of images existing within the remote data store and/or prevent new images from being added to a set of existing images existing within the remote data store by determining whether images sharing the same location index also share the same environmental parameters.

For example, when a set of images (e.g., existing images or a combination of new and existing images) captured for the same or similar GPS location, same street name, and same vehicle travel direction on the street, then the remote processor is adapted to determine that the set of images share the same location index. Within the set of images sharing the same location index, when a subset of the images are associated with data indicating that they were captured under the same or similar environmental conditions (e.g., lighting conditions, seasonal conditions, weather conditions, traffic conditions, etc.), the remote processor is adapted to determine that the subset of images share the same environmental parameters.

In one embodiment, not all lighting conditions, seasonal conditions, weather conditions, and traffic conditions need to be the same for the remote processor to determine that two images have the same environmental parameters. For example, some embodiments may not catalog images by traffic conditions. In another embodiment, other conditions may be used in addition to, or instead of, some of the environmental conditions described above in the image thinning process.

Upon determining that images share the same location index and the same environmental parameters, one or more images may be removed from and/or rejected from being uploaded to the remote data store. In one embodiment, the image thinning circuitry embodied within the remote processor may be adapted to perform the removal/rejection process by removing/rejecting the least up-to-date image or images. This may be accomplished by, for example, comparing the dates and times at which the images were captured (the dates and times being stored along with the images in the image database as described previously) and eliminating one or more images from the database that is the oldest chronologically and/or rejecting one or more images from being added to the database if that image is older chronologically than one or more already present images in the database. In another example, the image thinning circuitry may be adapted to assign a lower priority to older images than younger images because if older images are more likely to be out of date (e.g., in urban locations). In one embodiment, the image thinning circuitry embodied within the remote processor may be adapted to perform the removal/rejection process prioritizes based upon chronological differences between images only if that chronological difference is greater than an assigned threshold. For example, if the assigned threshold is 2 weeks a, first image will receive a lower chronological priority than a second image if the remote processor determines that the first image is more than two weeks older than the second image. By eliminating older images from the remote database and/or not adding older images to the remote database as described above, the remote database may be maintained with the most up-to-date images for access by users.

In many cases, the most up-to-date images may not be the most representative of the location and environmental conditions captured. To address this fact, and in another embodiment, the image thinning circuitry embodied within the remote processor may be adapted to consider both the chronological order in which images were captured in addition to considering how well the data for certain environmental conditions match a target set of data for those environmental conditions. Thus, the image thinning circuitry embodied within the remote processor may be adapted to consider both the chronological age of captured images and the closeness of certain environmental conditions associated with the captured images to target environmental conditions when determining which images are to be removed from and/or rejected from being uploaded to the remote data store.

In one exemplary embodiment, the time-of-day in which an image was captured may be compared with a target time-of-day that reflects an archetypical daylight lighting condition, archetypical nighttime lighting condition, archetypical dawn lighting condition, and/or archetypical dusk lighting conditions for the particular date and location in which the image was captured. Thus, for example, a first image that was captured 3 minutes prior to dusk, as determined by the sunrise and sunset data for that particular location and particular date, would be assigned higher priority by the image thinning circuitry than a second image captured 12 minutes prior to dusk, for the first image is more likely to accurately represent a dusk scene. Accordingly, the higher priority assigned indicates a reduced likelihood that the first image will be eliminated by the image thinning circuitry and/or an increased likelihood that the second image will be eliminated by the image thinning circuitry. Other factors may also be considered that also affect the priority of the images as assigned by the image thinning process.

In one embodiment, the image thinning circuitry embodied within the remote processor may be adapted to access a database of, for example, target times and/or ranges of target times for certain target indexed lighting conditions. For example, daylight images may be assigned a target daylight range of 11:00 AM to 2:00 PM. Accordingly, the image thinning circuitry embodied within the remote processor may be adapted to assign an image captured within the exemplary daylight range a higher priority as an archetypical daylight image than an image captured outside that target daylight range. Moreover, the image thinning circuitry embodied within the remote processor may be adapted to assign images captured at times near the center of the exemplary target daylight range a higher priority as an archetypical daylight image than an image captured at the periphery of the target daylight range. Similarly, nighttime images may be assigned a target nighttime range of 10:00 PM to 3:00 AM. Accordingly, the image thinning circuitry embodied within the remote processor may be adapted to assign an image captured within the exemplary target nighttime range a higher priority as an archetypical nighttime image than an image captured outside that target nighttime range. Moreover, the image thinning circuitry embodied within the remote processor may be adapted to assign images captured at times near the center of the exemplary target nighttime range a higher priority as an archetypical nighttime image than an image captured at the periphery of the target nighttime range.

Similar to the lighting condition ranges described above, the image thinning circuitry embodied within the remote processor may be adapted to access a database of, for example, target dates and/or ranges of target dates for certain target indexed seasonal conditions. In one embodiment, the target dates and/or ranges of target dates may be associated with particular locations. For example, winter images may be assigned a target winter date range of December 28th to January 31st for certain target locations. Accordingly, the image thinning circuitry embodied within the remote processor may be adapted to assign an image captured within the exemplary target winter date range a higher priority as an archetypical winter image than an image captured outside that target winter date range. Moreover, the image thinning circuitry embodied within the remote processor may be adapted to assign images captured at times near the center of the exemplary target winter date range a higher priority as an archetypical winter image than an image captured at the periphery of the target winter date range. Similarly, summer images may be assigned a target summer date range of June 20th to August 7th for certain target locations. Accordingly, the image thinning circuitry embodied within the remote processor may be adapted to assign an image captured within the exemplary target summer date range a higher priority as an archetypical summer image than an image captured outside that target summer date range. Moreover, the image thinning circuitry embodied within the remote processor may be adapted to assign images captured at times near the center of the exemplary target summer date range a higher priority as an archetypical summer image than an image captured at the periphery of the target summer date range.

In one embodiment, image thinning circuitry embodied within the remote processor is adapted to consider multiple prioritizing factors when determining which images are to be removed from and/or rejected from being added to the one or more centralized image databases. For example, an image of a particular location that is indexed as a summer image of that location and a nighttime image of that location may be thinned based both on the how close the time at which the image was captured matches a target nighttime time and how close the date at which the image was captured matches a target summer date. In this way, the images that are removed from and/or rejected from being added to the one or more centralized image databases are those that are less likely to reflect an archetypical summer nighttime image of that particular location. In addition, if multiple images were being considered by image thinning circuitry embodied within the remote processor, and those multiple images had similar priority in terms of their likelihood of reflecting a typical summer nighttime image as determined by the date and time comparisons above, the image that was captured most recently (i.e., the image that is most recent in date) would be assigned the highest priority because that image is the least likely of being out of date.

Data indicating GPS location is not perfect and may vary due to error based upon the number of satellites visible to the GPS receiver in the sky, solar flairs, and/or other technical or environmental variables that may reduce the accuracy and/or confidence level of the calculated GPS location. Accordingly, and in one embodiment, image thinning circuitry embodied within the remote processor may be adapted to use data indicative of GPS location confidence level to assign priority to captured images. In such an embodiment, images associated with data indicative of a high GPS location confidence level may be assigned a higher priority than images that are associated with data indicative of a low GPS location confidence level. In this way, the images that are associated with higher GPS location confidence levels are more likely to be kept within and/or added to the one or more centralized image databases than images that are associated with lower GPS location confidence levels.

In one embodiment, the image thinning circuitry embodied within the remote processor is adapted to receive subjective rating data provided by the user in response to a query. In one embodiment, the image-enhanced vehicle navigation system may include a user interface adapted to be engaged by the user and allow the user to respond to a query by entering his or her subjective rating data. The query may be presented to the user via the display screen 202 when the user is viewing a displayed image of a particular location under particular environmental conditions and is directly viewing from his or her vehicle that same particular location under those same particular environmental conditions.

Such a query may ask the user to enter his or her subjective rating data to indicate how well the image currently displayed on the display screen 202 matches his or her direct view of the location through the windshield under the particular environmental conditions. The subjective rating data can be, for example, a rating on a subjective scale from 1 to 10, with 1 being the worst match and 10 being the best match. The subjective impression about the degree of match may be entered by the user entering a number, for example a number between 1 and 10, may be entered by the user manipulating a graphical slider along a range that represents the subjective rating range, or may be entered by some other graphical user interface interaction.

In one embodiment, the subjective rating data may be saved along with the displayed image as an indication of the quality of the image to match the location index and the environmental parameters. In another embodiment, the remote processor is adapted to compare the subjective rating data with subjective rating data saved with other images (duplicates) as part of the image thinning process described previously. In such embodiments, image thinning circuitry embodied within the remote processor is adapted to assign priority to captured images based (in part or in whole) upon the subjective rating data, wherein images associated with higher subjective ratings from users are less likely to be removed from the database when duplicate images exist.

In one embodiment, the subjective rating data is saved as a direct representation of the rating entered by the user. In another embodiment, the subjective rating data given by a particular user is normalized and/or otherwise scaled to reflect the tendencies of that user as compared to other users. For example, a first user may typically rate images higher than a second user when expressing their subjective intent. To allow the ratings given by the first and second users to be compared by the image thinning circuitry embodied within the remote processor in a fair and meaningful way, the ratings given by each user can be normalized by dividing the ratings by the average ratings given by each user over some period of time. The normalized values can then be compared. In another embodiment, other statistical methods can be used to normalize or otherwise scale the ratings given by each user for more meaningful comparison.

In one embodiment, during the query process, the user may be prompted to answer a series of questions about the image on the display screen as it compares to his or her direct view of the surroundings and the user may be prompted to answer some general questions or prompts about the image quality. For example, these questions may include, but are not limited to, one or more of the following—“Please rate the overall image quality of the displayed image.”—“How well does the displayed image match your direct view out the windshield at the current time?”—“How well does the location displayed in the image match the location seen out your windshield?”—“How well does the lighting conditions displayed in the image match the lighting conditions seen out your windshield?”—“How well do the weather conditions match the weather conditions seen out your windshield?”—“How well do the snow accumulation conditions match the snow accumulation conditions seen out your windshield?”—“Does the image appear to be an up-to-date representation of the image seen out your windshield?”—“How well does the field of view represented in the image match the field of view seen out your windshield?”—“Overall, please rate the quality of the image in its ability to help you identify the view seen out your windshield.” In one embodiment, the image thinning circuitry embodied within the remote processor may intelligently select which questions to ask based upon the thinning parameters in question. For example, if multiple duplicate images are being considered, some images being definitively better than other images based upon certain stored parameters, but other parameters providing unclear comparisons, the image thinning circuitry embodied within the remote processor may prompt the user to provide information about those aspects of the comparison that are not definitive based upon the stored data alone.

In one embodiment, during the query process, one or more questions about a captured image may be posed to the user via the user interface at the time the image was captured—provided that the vehicle is not moving. For example, the user may be sitting at a red light and an image may be captured by the camera mounted upon his or her vehicle. Because the image was captured at a time when the vehicle was not moving and the driver may have time to enter some subjective data about the image, one or more of the subjective questions may be prompted to the user. In one embodiment, the user need not answer the question if he or she does not choose to. In another embodiment, the question may be removed from the screen when the user resumes driving the vehicle again and/or if the vehicle moves by more than some threshold distance. In this way, a user need not take any special action if he or she does not choose to provide a subjective rating response. In another embodiment, the user interface for responding to the prompts may be configured partially or fully upon the steering wheel of the vehicle to provide easy access to the user.

In one embodiment, image thinning circuitry embodied within the remote processor may include image processing circuitry adapted to compare a group of images sharing a particular location index and environmental parameter set, remove one or more of the images that are statistically most dissimilar from the group, and keep those images that are statistically most similar to the group. In such an embodiment, it may be valuable to maintain a number of duplicate images in the one or more centralized image databases for statistical purposes. Accordingly, the image thinning circuitry embodied within the remote processor may be configured in correspondence with how many duplicate images are to be kept and how many duplicate images are to be removed. In one embodiment, all duplicate images are kept in a main centralized image database and/or in a supplemental centralized image database, wherein the most archetypical image of each set of duplicate images is flagged, indicating that it will be the one that is retrieved when a search is performed by a user. In this way, the images are thinned from the database but still may be kept for other purposes.

In one embodiment, the image thinning circuitry embodied within the remote processor may be used to remove and/or assign priority to images based upon the quality of images (e.g., focus quality, presence of blurring) as determined by the image processing circuitry. For example, the image processing circuitry can be adapted to quantify the level of blur present within a captured image (the blur likely being the result of the vehicle moving forward, turning, hitting a bump or pothole, etc., at the time the image was captured). Depending upon the speed of the vehicle, the degree of any turns captured, the intensity of any bumps or holes, etc., the level of blur can vary greatly from image to image. Accordingly, the image processing circuitry may be used to removing images that are not as crisp as others because of blur and/or focus deficiencies. It will be appreciated that the speed at which a vehicle is moving often has the greatest affect upon image blur. Accordingly, and in one embodiment, the speed at which the vehicle was moving at the time when an image was captured can be recorded and used in rating, prioritizing, and removing/rejecting captured images. In such embodiments, the remote processor may contain circuitry adapted to assign a higher priority to images captured by slower moving vehicles as compared to images captured by faster moving vehicles. Furthermore, the remote processor may contain circuitry adapted to assign a highest possible priority or rating to images captured when a vehicle is at rest (only vehicles at rest are typically sure to be substantially free from blur do to forward motion, turning motion, hitting bumps, and/or hitting potholes). In one embodiment, an accelerometer is mounted to the vehicle (e.g., at a location near to where the camera is mounted) to record jolts, bumps, and other sudden changes in acceleration that may affect the image quality. Accordingly, a measure of the accelerometer data may also be stored along with captured images in the remote data store. In another embodiment, the user can manually enter information about the image quality of the manually captured image and store the image quality information in the database, the image quality information associated with the image. In another embodiment, the manually entered image quality information includes information about the focus of the image and/or the blurriness of the image and/or the field of view of the image and/or the clarity of the image.

It will be understood that methods and systems adapted to remove images from and/or reject images from being uploaded to the remote data store, according to any of the embodiments mentioned in the paragraphs above, may be implemented alone or in combination.

While the methods and apparatus have been discussed above with respect to images captured by a camera mounted upon automobiles, it will be appreciated that the numerous embodiments discussed above may be applied to images captured from other ground vehicles such as bicycles, motorcycles, etc., or to images captured from a person walking or running. Also, while the methods and apparatus have been discussed above with respect to images captured by a camera mounted upon manned automobiles, it will be appreciated that the numerous embodiments discussed above may be applied to images captured from other unmanned vehicles such as automated or robotic cars or trucks that may not have a driver present during the image capture process.

When a large number or percentage of vehicles within a particular geographic region are equipped with the image-enhanced vehicle navigation system as set forth in the exemplary embodiments above, a vast and continuously updated database of images captured and uploaded to one or more centrally accessible databases and provide additional features to users such as a “real-time look-ahead” feature. This feature involves a user accessing and viewing the most frequently updated image captured by a vehicle or vehicles traveling along the same planned route as the user's vehicle as a way to access “near real-time” imagery of what to expect on the streets ahead. Such a feature may be useful in high traffic situations, inclement weather situations, high-snow situations, construction situations, accident situations, or any other situation involving adverse driving conditions.

For example, thousands of vehicles, all equipped with the image-enhanced vehicle navigation system as set forth in the exemplary embodiments above, may be traveling the busy 101 freeway in the Los Angeles area. A large number of the vehicles may be running their own image capture processes (automatic or manual), capturing real time images based upon their changing locations as they travel the busy 101 freeway. Part of the freeway may be highly congested (e.g., because of an accident) such that the vehicles move at a stop-and-go pace while other parts of the freeway may be moving well. Images captured by the vehicles depict the traffic density at many parts of the freeway and are frequently updated as the vehicles move about the Los Angeles area. A user of the system traveling on highway 101 may access a centralized database and request image data for locations ahead along the freeway. The images may have been updated only seconds or minutes prior, captured by vehicles traveling along the same street but further ahead. The user can, for example, look-ahead a prescribed distance from his current location—for example a quarter mile. The user can keep this quarter mile setting active such that his or her navigation display will continually be updated with images that are a quarter mile ahead, the images updated based upon the changing location of the user's vehicle as it moves along the freeway. For example, every time the user's vehicle moves ahead ten meters, a new image is displayed to the user, the image depicting a scene of the highway located a quarter mile ahead of the new location. In this way, as the user drives along the freeway, he or she can look down at the display and check what is happening on the freeway a quarter mile ahead. In one embodiment, the user can manipulate the user interface of the navigation system to change the look-ahead distance, adjusting it for example from a quarter mile to a half mile to a full mile if the user wants to see what is happening on the freeway even further ahead. In one embodiment, the user interface that allows the user to adjust the look-ahead distance is very easy to manipulate being, for example, a graphical slider that can be adjusted through a touch screen to adjust the look-ahead distance or being a physical knob that can be turned between the fingers to adjust the look-ahead distance. In one embodiment, the physical knob is located upon or adjacent to the steering wheel of the vehicle such that the user can easily manipulate the knob to adjust the look-ahead distance forward and/or backwards (ideally without removing his or her hand from the steering wheel). In this way, the user can adjust the knob while he or she is driving and scan up and down the highway at varying distances from the user's vehicles current location. In one embodiment, the look-ahead distance can be as small as a 1/16 mile and can be as far as tens of miles or more. In this way, the user can scroll the knob and quickly view the expected path of travel starting from just head and scrolling forward through the image database along the current path of travel, past intermediate destinations, to the final destination if desired. To achieve this, the local processor accessing (i.e., obtaining) images from the database correlates the accessed images with the planned route of travel.

A more detailed description of the real-time look-ahead feature will now be presented. When the real-time look-ahead feature is engaged, a look-ahead distance D_LOOK_AHEAD is assigned a value. In one exemplary embodiment, the look-ahead distance D_LOOK_AHEAD is initially assigned a value of 0.25 miles. It will be appreciated that the user can adjust this distance in real time by manipulating a user interface. In one embodiment, the user interface is a sensored knob. In another embodiment, the knob is a continuous turn wheel adapted to be engaged by one or more fingers while the user is holding the steering wheel, wherein the turn wheel is adapted to turn an optical encoder and the optical encoder is interfaced to electronics adapted to send data to the local processor running the driving the screen 202. In one embodiment, the user rolls the knob to adjust the look-ahead distance value up and down. In another embodiment, the look-ahead distance is incremented up and down linearly with rotation (or non-linearly such that the increments get larger as the look-ahead distance gets larger). For example, as the user rolls the knob forward, the look-ahead distance increases and as the user rolls the knob back the look-ahead distance decreases. In one embodiment, the look-ahead distance has a minimum value that is 1/16 of a mile ahead. In another embodiment, the look-ahead distance can be set to 0, in which case the camera upon the user's own vehicle sends real time images to the screen 202. In one embodiment, the look-ahead distance can be set negative in which case images are displayed at incremental distances behind the user's vehicle along the user's previous route of travel. Negative look-ahead distances may be useful when a user is driving along with other vehicles on a group street-trip and may wonder what traffic looks like behind him where his or her friends may be. As the knob is adjusted, the value D_LOOK_AHEAD is updated, the value being accessible to the local processor adapted to drive the display screen 202. The local processor may also run navigation planning routines, the navigation planning routines including a model of the user's planned route of travel. The local processor, accessing GPS data, determines where on the planned route of travel the user's vehicle is currently located at. The local processor then adds to the location a distance offset equal to D_LOOK_AHEAD and accesses an image from a centralized database for that offset location and displays the image upon the screen 202 of the navigation display. The image is updated as the GPS location of the vehicle changes and/or as the value D_LOOK_AHEAD is adjusted by the user. In one embodiment, the vehicle's direction of travel is also used by the image display routines in determining which way upon a given street the user's vehicle is traveling. The direction of travel can be determined in any manner as described above. In another embodiment, a numerical value and/or graphical meter is also displayed upon the navigation display that indicates the then current look-ahead distance as stored within D_LOOK_AHEAD. This allows the user to know how far ahead from the user's current location the currently displayed image represents.

According to numerous embodiments, the user can enter a written message or audio note (herein collectively referred to as “reminder data”) associated with the manually initiated image capture and/or another manually triggered event. In one embodiment, the reminder data is stored locally and not downloaded to the remote data store. Accordingly, the reminder data is personal and is associated with the captured image, the identified location, a particular direction of travel, particular environmental conditions, or any other of the aforementioned correlation data (collectively referred to as “reminder correlation data”). In another embodiment, the reminder data is uploaded to the remote data store along with the captured image. Accordingly, the reminder data is public is associated with the captured image, the identified location, a particular direction of travel, and/or particular environmental conditions.

Whether private or public, the local processor is adapted to receive the reminder data via the user interface of the image-enhanced vehicle navigation system and associate the reminder data with a particular image of a particular location, with the location itself, with a particular direction of travel toward the particular location, and/or with particular environmental conditions. For example, a manually initiated image capture may result in an image of an exit off a freeway being captured. The exit might be particularly treacherous with respect to merging traffic. The user, noting that the exit is particularly treacherous, may choose (by appropriately engaging the user interface of the navigation system) to enter a written message and/or audio note and associate that message/note with the captured image of the exit, with the GPS location of the exit, with a particular direction of travel towards the exit, and/or with particular environmental conditions. In one embodiment, the user interface includes a microphone incorporated within or connected to the vehicle navigation system such that the user enters an audio note by speaking into the microphone. The microphone captures the audio note and suitable circuitry within the image-enhanced vehicle navigation system stores the audio note as a digitized digital audio file. The digital audio file is then saved locally and/or uploaded to a remote data store and is linked to and/or associated with the image of the exit, the GPS location of the exit, a particular direction of travel toward the exit, and/or particular environmental conditions. In one embodiment, the user can associate a given written message or audio note to all images associated with a given GPS location.

When the user makes a future trip and returns to a location such that the image of the treacherous exit is displayed to the user, the written message and/or audio note that the user recorded warning himself or herself about the treacherousness of merging traffic is accessed and displayed to the user by the methods and systems described herein. In the case of a written message, the text is displayed upon the screen 202 of the navigation system (e.g., overlaid upon the image of the exit, along side the image of the exit, etc.). In the case of an audio note, the audio file is played through the speakers of the vehicle audio system, through dedicated speakers as part of the vehicle navigation system, or the like, or combinations thereof.

Because the user may want the written message or audio note to be presented to him or her whenever he or she approaches the exit, the written message or audio note may not be associated only with the particular image of the exit but may be associated with all images of the exit as would be seen when approaching the exit from that direction. Accordingly, and in one embodiment, a user-entered written message and/or a user-entered audio file can be associated with a particular GPS location and direction of travel and, optionally, a particular street name or index. Thus, any time the user approaches that location from that particular direction upon that particular street, the written message or audio note is accessed and displayed to the user.

Some user-entered written messages or audio files may be associated with specific environmental conditions such as icy weather, heavy traffic, or dark lighting conditions. Accordingly, and in one embodiment, a user can link specific environmental conditions supported by the system to the written message or audio file. For example, the user may record an audio note to himself—“go slow in the rain” when making a particularly dangerous turn onto a particular street. The user can link then that audio note within the database to the particular GPS location and particular direction of travel associated with that particularly dangerous turn, as well as link the audio note with the environmental condition of rain, by entering his linkage desires through the user interface of the navigation system. As mentioned above, the user can also indicate through the user interface whether the audio note should be personal (i.e., only accessible by his or her vehicle) or should be public (i.e., accessible to any vehicle that goes to that particular location with that particular direction of travel under those particular environmental conditions).

In one embodiment, the user can associate a particular written message and/or audio note with a particular date or range of dates and/or time or range of times. For example, the user can create an audio note to himself—“Don't forget to pick up your laundry from the drycleaners” and associate that note with a particular street and direction of travel such that whenever he drives his vehicle on that street in that particular direction, the audio note is accessed and displayed. Because the dry cleaning might not be ready until Thursday of that week, he could choose to associate that audio message also with a date range that starts at Thursday of that week and continues for five days thereafter. In this way, the audio note is only presented to the user during that date range. If the street in question is very long, the user may only desire that the audio message be accessed at or near a particular part of the street. To achieve this, he can also link the audio message with a particular GPS location. In one embodiment, the user can also enter a proximity to the location that triggers the accessing and display of the audio note. In this way, the image-enhanced vehicle navigation system can be configured to access and display this particular audio note when the user is driving on a particular street and is within a certain defined proximity of a certain target GPS location and is traveling in a particular direction along the street (for example northbound) and the date is within a particular defined range. Furthermore, the user may not wish to hear that audio message repeatedly while the previously mentioned conditions are met. Accordingly, and in one embodiment, the local processor within the image-enhanced vehicle navigation system can be configured with a minimum access interval adapted to limit how often a particular written message, audio note, or accessed image can be displayed to a user within a particular amount of time. For example, if the minimum access interval is set to 15 minutes, then during times when all conditions are met, the written message, audio note, or accessed image, will not be displayed by the local processor more than once per 15 every minute time interval.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for capturing, storing, and presenting driver's eye photographic images, the method comprising:
Capturing a plurality of driver's eye photographic images using a processor controlled digital camera coupled to a ground vehicle moving upon streets of travel, each of the plurality of driver's eye photographic images depicting a view corresponding approximately with a driver's perspective upon the streets of travel;
Storing the plurality of driver's eye photographic images in an image database such that each of the plurality of driver's eye photographic images is indexed with respect to a particular street of travel, a location upon the particular street of travel, and a direction of travel upon the particular street of travel;
Accessing an at least one driver's eye photographic image from the image database based at least in part upon an input from a user, the input from the user comprising an indication of at least one of a destination location and a look-ahead distance; and
Displaying the at least one driver's eye photographic image to the user upon a display screen.

2. The method of claim 1 wherein the direction of travel is one of a northbound, southbound, eastbound, and westbound traffic flow.

3. The method of claim 1 wherein each of the plurality of driver's eye photographic images stored within the image database is further indexed with respect to a weather condition.

4. The method of claim 3 wherein the weather condition is at least one of a clear, cloudy, partly cloudy, rainy, overcast, snowy, and foggy.

5. The method of claim 3 wherein a remote storage of weather data is accessed to predict a weather condition for a particular location.

6. The method of claim 3 wherein a user interface is provided that enables the user to specify a particular weather condition.

7. The method of claim 1 wherein each of the plurality of driver's eye photographic images stored within the image database is further indexed with respect to a seasonal condition.

8. The method of claim 7 wherein the seasonal condition is at least one of a summer, spring, winter, and fall.

9. The method of claim 1 wherein each of the plurality of driver's eye photographic images stored within the image database is further indexed with respect to a lighting condition.

10. The method of claim 9 wherein the lighting condition is at least one of a daylight, nighttime, sunset, and sunrise.

11. The method of claim 9 wherein an at least one of a sunrise and a sunset times is accessed to predict a lighting condition for a particular time and date.

12. The method of claim 1 wherein each of the plurality of driver's eye photographic images stored within the image database is further indexed with respect to a traffic condition.

13. The method of claim 12 wherein the traffic condition is at least one of a light, moderate, and heavy traffic.

14. The method of claim 1 wherein at least one of the plurality of driver's eye photographic images stored within the image database is associated with a user rating, the user rating indicating a subjective rating provided by a user.

15. The method of claim 14 wherein the user rating indicates a subjective rating of an image quality.

16. The method of claim 1 wherein the user may engage a user interface to selectively switch between viewing a map type display and viewing the at least one driver's eye photographic image upon the display screen.

17. The method of claim 1 wherein the user may engage a user interface to incrementally adjust a look-ahead distance used in accessing and displaying the at least one driver's eye photographic image.

18. The method of claim 17 wherein the user interface is at least one of a graphical slider and a physical knob that is manipulated by the user.

19. The method of claim 1 wherein the at least one driver's eye photographic image accessed and displayed to the user is accessed from the image database based at least in part upon a current location of the user.

20. The method of claim 1 wherein the at least one driver's eye photographic images accessed and displayed to the user is accessed from the image database based at least in part upon a current direction of travel of the user.

21. The method of claim 1 wherein the at least one driver's eye photographic images accessed and displayed to the user is accessed from the image database based at least in part upon a predicted or estimated time when the user's vehicle will reach a particular location.

22. A method for maintaining an image database of driver's eye photographic images for user access and viewing, the method comprising:
Providing a processor controlled digital camera mounted on a moving ground vehicle and configured to take photographic images that depict a view that corresponds approximately to a driver's perspective upon a street of travel;
Capturing a plurality of photographic images with the processor controlled digital camera, the plurality of photographic images being automatically captured under a processor control at incremental distances along the street of travel.
Storing the plurality of photographic images in the image database such that each of the plurality of photographic images is indexed with respect to the street of travel, a location upon the street of travel, and a direction of travel upon the street of travel.

23. The method of claim 22 wherein the processor controlled digital camera captures the plurality of photographic images at incremental distances in response to GPS data captured from a sensor proximal to the moving ground vehicle.

24. The method of claim 22 wherein the direction of travel is one of a northbound, southbound, eastbound, and westbound, direction of traffic flow.

25. The method of claim 22 wherein each of the plurality photographic images stored within the image database is further indexed with respect to a weather condition.

26. The method of claim 25 wherein the weather condition is at least one of a clear, cloudy, partly cloudy, rainy, overcast, snowy, and foggy.

27. The method of claim 22 wherein each of the plurality of photographic images stored within the image database is further indexed with respect to a seasonal condition.

28. The method of claim 27 wherein the seasonal condition is at least one of a summer, spring, winter, and fall.

29. The method of claim 22 wherein each of the plurality of photographic images stored within the image database is further indexed with respect to a lighting condition.

30. The method of claim 29 wherein the lighting condition is at least one of a daylight, nighttime, sunset, and sunrise.

31. The method of claim 22 wherein each of the plurality of photographic images stored within the image database is further indexed with respect to a traffic condition.

32. The method of claim 31 wherein the traffic condition is at least one of a light, moderate, and heavy.

33. The method of claim 22 wherein each of the plurality of photographic images stored within the image database is associated with an at least one user rating, the at least one user rating indicating a subjective rating provided by a user.

34. The method of claim 33 wherein the user rating is a subjective rating of an image quality.

35. The method of claim 22 further comprising accessing and displaying an at least one photographic image from the image database, the accessing and displaying being performed based at least in part upon input from a user comprising an indication of at least one of a destination location and a look-ahead distance.

36. The method of claim 35 wherein the user may engage a user interface to incrementally adjust a look-ahead distance used in the accessing and displaying the at least one photographic image from the image database.

37. The method of claim 36 wherein the user interface is at least one of a graphical slider and a physical knob that is manipulated by the user.

38. The method of claim 22 further comprising repeatedly performing the steps of providing, capturing, and storing, each repetition being performed for a different street of travel.

39. A method for accessing and displaying driver's eye photographic images, the method comprising:
Accessing an image database including a plurality of driver's eye photographic images, each of the plurality of driver's eye photographic images depicting a view corresponding approximately with a driver's perspective upon a street of travel, each of the plurality of driver's eye photographic images being indexed with respect to the particular street upon which the image was captured and a direction of travel upon the particular street;
Selecting at least one driver's eye photographic image from the image database, the selecting being performed based at least in part upon an indicated street and an indicated travel direction with respect to the indicated street; and
Displaying the one or more selected images to a user upon a display screen.

40. The method of claim 39 wherein the indicated travel direction is one of a northbound, southbound, eastbound, and westbound direction of traffic flow.

41. The method of claim 39 wherein the selecting is also based at least in part upon a seasonal condition.

42. The method of claim 39 wherein the selecting is also based at least in part upon a weather condition;

43. The method of claim 39 wherein the selecting is also based at least in part upon a designated travel route generated by a navigation planning system.

44. The method of claim 39 wherein the user may engage a user interface to selectively switch between viewing a map and viewing the at least one driver's eye photographic image upon the display screen.

45. The method of claim 39 wherein the selecting is based at least in part upon user manipulation of a user interface control, the user interface control being at least one of a graphical slider and a physical knob engaged by the user.

46. The method of claim 39 wherein the selecting is also based at least in part upon a lighting condition.
